(19) United States
(12) Patent Application Publication
(10) Pub. No.: US 2025/0165213 A1
(43) Pub. Date: May 22, 2025

(54) INFORMATION PROCESSING APPARATUS AND CONTROL METHOD

(71) Applicant: TOYOTA JIDOSHA KABUSHIKI KAISHA, Toyota-shi (JP)

(72) Inventors: Yu NAGATA, Chofu-shi (JP); Ryota YANAGISAWA, Ota-ku (JP); Akira MIYAMOTO, Nisshin-shi (JP); Eiichi MAEDA, Asaka-shi (JP); Haruto TOYAMA, Nagoya-shi (JP); Kotaro HIROSE, Nisshin-shi (JP); Yasuhiro KOBATAKE, Nagoya-shi (JP)

(73) Assignee: TOYOTA JIDOSHA KABUSHIKI KAISHA, Toyota-shi (JP)

(21) Appl. No.: 18/920,991

(22) Filed: Oct. 21, 2024

(30) Foreign Application Priority Data
Nov. 21, 2023 (JP) 2023-197754

(51) Int. Cl. G06F 3/16; B60W 40/08

(52) U.S. Cl. CPC G06F 3/167; B60W 40/08; B60W 2540/043; B60W 2540/21

(57) ABSTRACT

An information processing apparatus includes a controller configured to control a function according to voice input from an occupant of a vehicle, identify the occupant, and adjust degree of conciseness of a response to the voice input depending on the identified occupant.

### CROSS-REFERENCE TO RELATED APPLICATION

This application claims priority to Japanese Patent Application No. 2023-197754, filed on Nov. 21, 2023, the entire contents of which are incorporated herein by reference.

### TECHNICAL FIELD

The present disclosure relates to an information processing apparatus and a control method.

### BACKGROUND

Patent Literature (PTL) 1 discloses a method of responding to voice input from users.

### CITATION LIST

### Patent Literature

PTL 1: JP 2022-102305 A

### SUMMARY

In the conventional method, the responses to the voice input are uniform for each speaker. As a result, convenience is insufficient.

It would be helpful to improve the convenience of technology for outputting responses to voice input.

An information processing apparatus according to the present disclosure includes a controller configured to:
control a function according to voice input from an occupant of a vehicle;
identify the occupant; and
adjust degree of conciseness of a response to the voice input depending on the identified occupant.

A control method according to the present disclosure includes:
controlling, by a computer, a function according to voice input from an occupant of a vehicle;
identifying, by the computer, the occupant; and
adjusting, by the computer, degree of conciseness of a response to the voice input depending on the identified occupant.

According to the present disclosure, the degree of conciseness of responses as output to voice input can be changed according to the user, which improves convenience.

### BRIEF DESCRIPTION OF THE DRAWINGS

In the accompanying drawings:

FIG. 1 is a diagram illustrating a configuration of a system according to an embodiment of the present disclosure;

FIG. 2 is a block diagram illustrating a configuration of an information processing apparatus according to the embodiment of the present disclosure;

FIG. 3 is a table illustrating an example of usage status data according to the embodiment of the present disclosure;

FIG. 4 is a flowchart illustrating operations of the information processing apparatus according to the embodiment of the present disclosure; and

FIG. 5 is a flowchart illustrating a variation of the operations of the information processing apparatus according to the embodiment of the present disclosure.

### DETAILED DESCRIPTION

An embodiment of the present disclosure will be described below, with reference to the drawings.

In the drawings, the same or corresponding portions are denoted by the same reference numerals. In the descriptions of the present embodiment, detailed descriptions of the same or corresponding portions are omitted or simplified, as appropriate.

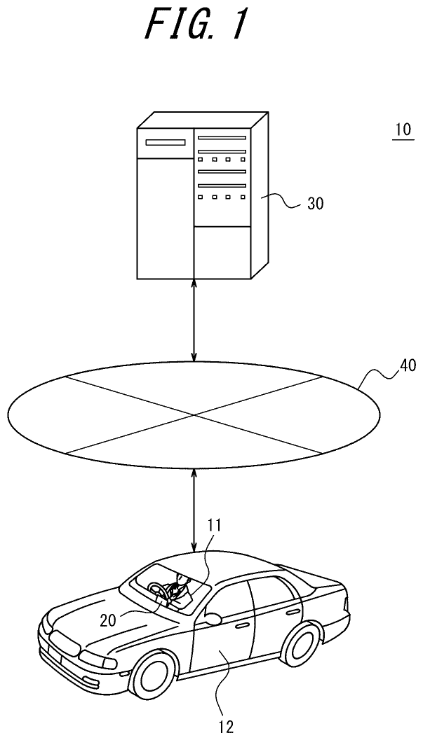

A configuration of a system 10 according to the present embodiment will be described with reference to FIG. 1.

The system 10 according to the present embodiment includes an information processing apparatus 20 and a server apparatus 30. The information processing apparatus 20 can communicate with the server apparatus 30 via a network 40.

The information processing apparatus 20 is a computer with voice recognition capability installed in a vehicle 12. The information processing apparatus 20 is used by a user 11. The user 11 is an occupant of the vehicle 12.

The server apparatus 30 is a computer that belongs to a cloud computing system or other computing system installed in a facility such as a data center. The server apparatus 30 is operated by a service provider, such as a web service provider.

The vehicle 12 is, for example, any type of automobile such as a gasoline vehicle, a diesel vehicle, a hydrogen vehicle, an HEV, a PHEV, a BEV, or an FCEV. The term “HEV” is an abbreviation of hybrid electric vehicle. The term “PHEV” is an abbreviation of plug-in hybrid electric vehicle. The term “BEV” is an abbreviation of battery electric vehicle. The term “FCEV” is an abbreviation of fuel cell electric vehicle. The vehicle 12 may be driven by the user 11, or the driving may be automated at any level. The automation level is, for example, any one of Level 1 to Level 5 according to the level classification defined by SAE. The name “SAE” is an abbreviation of Society of Automotive Engineers. The vehicle 12 may be a MaaS-dedicated vehicle. The term “MaaS” is an abbreviation of Mobility as a Service.

The network 40 includes the Internet, at least one WAN, at least one MAN, or any combination thereof. The term “WAN” is an abbreviation of wide area network. The term “MAN” is an abbreviation of metropolitan area network. The network 40 may include at least one wireless network, at least one optical network, or any combination thereof. The wireless network is, for example, an ad hoc network, a cellular network, a wireless LAN, a satellite communication network, or a terrestrial microwave network. The term “LAN” is an abbreviation of local area network.

An outline of the present embodiment will be described with reference to FIG. 1.

The information processing apparatus 20 controls a function according to voice input from the user 11. The information processing apparatus 20 identifies the user 11. The information processing apparatus 20 adjusts the degree of conciseness of a response to voice input according to the identified user 11.

According to the present embodiment, the degree of conciseness of the response as output to voice input can be changed according to the user 11, which improves convenience.

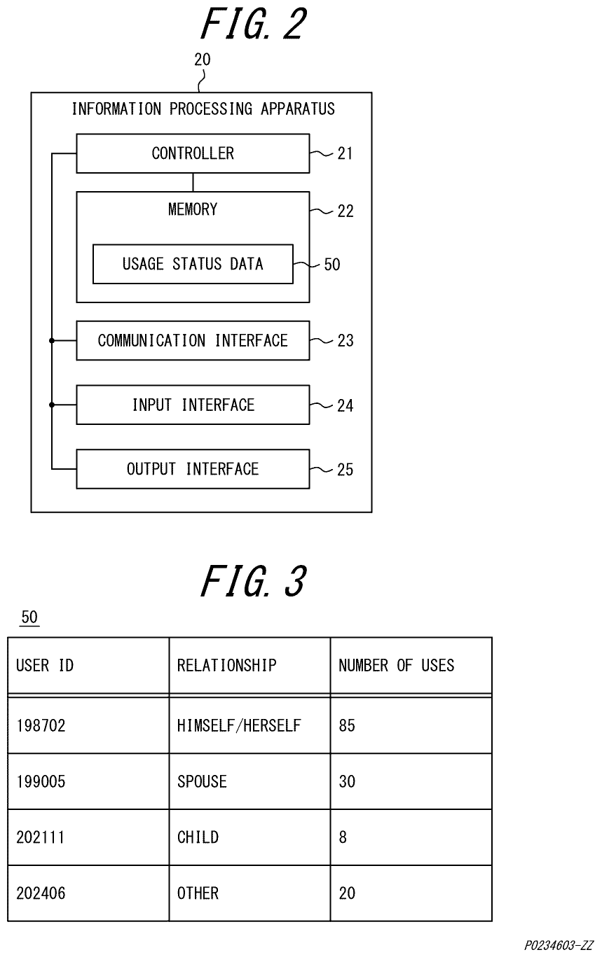

A configuration of the information processing apparatus 20 according to the present embodiment will be described with reference to FIG. 2.

The information processing apparatus 20 includes a controller 21, a memory 22, a communication interface 23, an input interface 24, and an output interface 25. In the memory 22, usage status data 50 indicating the user 11's usage status of the information processing apparatus 20 is stored.

The controller 21 includes at least one processor, at least one programmable circuit, at least one dedicated circuit, or any combination thereof. The processor is a general purpose processor such as a CPU or a GPU, or a dedicated processor that is dedicated to specific processing. The term “CPU” is an abbreviation of central processing unit. The term “GPU” is an abbreviation of graphics processing unit. The programmable circuit is, for example, an FPGA. The term “FPGA” is an abbreviation of field-programmable gate array. The dedicated circuit is, for example, an ASIC. The term “ASIC” is an abbreviation of application specific integrated circuit. The controller 21 executes processes related to operations of the information processing apparatus 20 while controlling components of the information processing apparatus 20.

The memory 22 includes at least one semiconductor memory, at least one magnetic memory, at least one optical memory, or any combination thereof. The semiconductor memory is, for example, RAM, ROM, or flash memory. The term “RAM” is an abbreviation of random access memory. The term “ROM” is an abbreviation of read only memory. The RAM is, for example, SRAM or DRAM. The term “SRAM” is an abbreviation of static random access memory. The term “DRAM” is an abbreviation of dynamic random access memory. The ROM is, for example, EEPROM. The term “EEPROM” is an abbreviation of electrically erasable programmable read only memory. The flash memory is, for example, SSD. The term “SSD” is an abbreviation of solid-state drive. The magnetic memory is, for example, HDD. The term “HDD” is an abbreviation of hard disk drive. The memory 22 functions as, for example, a main memory, an auxiliary memory, or a cache memory. The memory 22 stores data to be used in the operations of the information processing apparatus 20 and data obtained by the operations of the information processing apparatus 20.

The communication interface 23 includes at least one communication module. The communication module is, for example, a module compatible with a mobile communication standard such as LTE, the 4G standard, or the 5G standard, a wireless LAN communication standard such as IEEE802.11. The term “LTE” is an abbreviation of Long Term Evolution. The term “4G” is an abbreviation of 4th generation. The term “5G” is an abbreviation of 5th generation. The name “IEEE” is an abbreviation of Institute of Electrical and Electronics Engineers. The communication interface 23 communicates with the server apparatus 30. The communication interface 23 receives data to be used for the operations of the information processing apparatus 20, and transmits data obtained by the operations of the information processing apparatus 20.

The input interface 24 includes at least one input device. The input device is, for example, a physical key, a capacitive key, a pointing device, a touch screen integrally provided with a display, a visible light camera, a LiDAR sensor, or a microphone. The term “LiDAR” is an abbreviation of light detection and ranging. The input interface 24 accepts an operation for inputting data to be used for the operations of the information processing apparatus 20. The input interface 24, instead of being included in the information processing apparatus 20, may be connected to the information processing apparatus 20 as an external input device. As an interface for connection, an interface compliant with a standard such as USB, HDMI® (HDMI is a registered trademark in Japan, other countries, or both), or Bluetooth® (Bluetooth is a registered trademark in Japan, other countries, or both) can be used. The term “USB” is an abbreviation of Universal Serial Bus. The term “HDMI®” is an abbreviation of High-Definition Multimedia Interface.

The output interface 25 includes at least one output device. The output device is, for example, a display or a speaker. The display is, for example, an LCD or an organic EL display. The term “LCD” is an abbreviation of liquid crystal display. The term “EL” is an abbreviation of electro luminescent. The output interface 25 outputs data obtained by an operation of the information processing apparatus 20. The output interface 25, instead of being included in the information processing apparatus 20, may be connected to the information processing apparatus 20 as an external output device such as a display audio. As an interface for connection, an interface compliant with a standard such as USB, HDMI® (HDMI is a registered trademark in Japan, other countries, or both), or Bluetooth® (Bluetooth is a registered trademark in Japan, other countries, or both) can be used.

The functions of the information processing apparatus 20 are realized by execution of a program according to the present embodiment by a processor serving as the controller 21. That is, the functions of the information processing apparatus 20 are realized by software. The program causes a computer to execute the operations of the information processing apparatus 20, thereby causing the computer to function as the information processing apparatus 20. That is, the computer executes the operations of the information processing apparatus 20 in accordance with the program to thereby function as the information processing apparatus 20.

The program can be stored on a non-transitory computer readable medium. The non-transitory computer readable medium is, for example, flash memory, a magnetic recording device, an optical disc, a magneto-optical recording medium, or ROM. The program is distributed, for example, by selling, transferring, or lending a portable medium such as an SD card, a DVD, or a CD-ROM on which the program is stored. The term “SD” is an abbreviation of Secure Digital. The term “DVD” is an abbreviation of digital versatile disc. The term “CD-ROM” is an abbreviation of compact disc read only memory. The program may be distributed by storing the program in a storage of a server and transferring the program from the server to another computer. The program may be provided as a program product.

For example, the computer temporarily stores, in a main memory, a program stored in a portable medium or a program transferred from a server. Then, the computer reads the program stored in the main memory using a processor, and executes processes in accordance with the read program using the processor. The computer may read a program directly from the portable medium, and execute processes in accordance with the program. The computer may, each time a program is transferred from the server to the computer, sequentially execute processes in accordance with the received program. Instead of transferring a program from the server to the computer, processes may be executed by a so-called ASP type service that realizes functions only by execution instructions and result acquisitions. The term “ASP” is an abbreviation of application service provider. Programs encompass information that is to be used for processing by an electronic computer and is thus equivalent to a program. For example, data that is not a direct command to a computer but has a property that regulates processing of the computer is “equivalent to a program” in this context.

Some or all of the functions of the information processing apparatus 20 may be realized by a programmable circuit or a dedicated circuit serving as the controller 21. That is, some or all of the functions of the information processing apparatus 20 may be realized by hardware.

A configuration of the usage status data 50 according to the present embodiment will be described with reference to FIG. 3.

The usage status data 50 is configured as a table containing three columns: user ID, relationship, and number of uses. The term “ID” is an abbreviation of identifier. The “user ID” in the usage status data 50 is an ID assigned in advance to a user who may use the information processing apparatus 20. User IDs are pre-tied to voice data obtained by recording the corresponding user's voice. The “relationship” in the usage status data 50 is the relationship between each user and the owner of the vehicle 12. Here, each user is classified as one of the following categories: “Himself/herself”, “Spouse”, “Child”, and “Other. The “number of uses” in the usage status data 50 is the cumulative number of times each user has used the information processing apparatus 20, i.e., the cumulative number of times the information processing apparatus 20 has recognized voice input for each user. In addition to this, the usage status data 50 may also record the date each user used the information processing apparatus 20.

The usage status data 50 is stored in the memory 22 of the information processing apparatus 20 in the present embodiment, but may be stored in the server apparatus 30 or an external storage device.

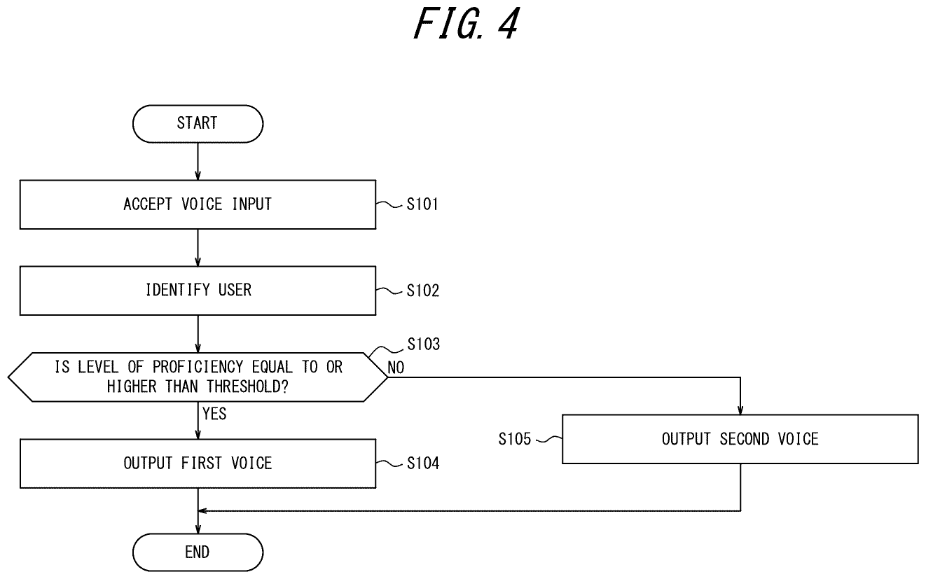

Operations of the information processing apparatus 20 according to the present embodiment will be described with reference to FIG. 4. The operations described below correspond to a control method according to the present embodiment. In other words, the control method according to the present embodiment includes steps S101 through S105 illustrated in FIG. 4.

Step S101 is initiated when the user 11 issues a startup command such as “Hey, car!” or by pressing a startup button on the screen display or a physically placed startup button.

In S101, the controller 21 accepts voice input from the user 11. For example, the controller 21 accepts voice input from the user 11, such as “I want to go to X” or “I want to listen to Y”, via a microphone as the input interface 24.

In S102, the controller 21 identifies the user 11. Specifically, the controller 21 identifies the user 11 by matching the voice input in S101 with the voice data of the user 11 previously recorded in the memory 22.

In S103, the controller 21 determines whether the user 11's level of proficiency in using the information processing apparatus 20 is equal to or higher than a threshold. Specifically, the controller 21 determines the level of proficiency with reference to the usage status data 50 as illustrated in FIG. 3. If the level of proficiency is equal to or higher than the threshold (S103—YES), the process proceeds to S104. If the level of proficiency is less than the threshold (S103—NO), the process proceeds to S105.

The “level of proficiency” is a measure of how familiar the user 11 is with the use of the information processing apparatus 20. In the present embodiment, the level of proficiency is determined from the number of uses of the information processing apparatus 20, as recorded in the usage status data 50. For example, the “number of uses” in the usage status data 50 is defined as the level of proficiency, and the threshold is 30. If the occupant who has input a voice “I want to go to X” in S101 is identified as the user corresponding to a user ID “198702” in the example illustrated in FIG. 3, the corresponding number of uses is 85. Therefore, the controller 21 determines that the level of proficiency is equal to or higher than the threshold and the process proceeds to S104. If the occupant who has input a voice “I want to listen to Y” in S101 is identified as the user corresponding to a user ID “202111” in the example illustrated in FIG. 3, the corresponding number of uses is 8. Therefore, the controller 21 determines that the level of proficiency is below the threshold and the process proceeds to S105. The process also proceeds to S105 if the user 11 is a user who is not registered in the usage status data 50.

The threshold is stored in the memory 22 in advance, or the controller 21 may receive it from the server apparatus 30.

In S104, the controller 21 outputs the first voice as a response to the voice input received in S101. Specifically, the controller 21 outputs, as the first voice, a voice that omits confirmation about the function according to the voice input from the user 11. In this way, the controller 21 increases the degree of conciseness of the response to voice input. For example, upon determining that the level of proficiency is equal to or higher than the threshold in S103 for an occupant who has input a voice “I want to go to X” in S101, the controller 21 outputs, as the first voice, a message of only “Understood”, which omits confirmation about a navigation device function, “X has been set as the destination”, from a speaker as the output interface 25. In this way, convenience can be further improved by making responses to users who are familiar with the information processing apparatus 20 more concise.

After S104, the flow illustrated in FIG. 4 ends.

In S105, the controller 21 outputs a second voice different from the first voice as a response to the voice input received in S101. Specifically, the controller 21 outputs, as the second voice, a voice including confirmation about the function according to the voice input from the user 11. For example, upon determining that the level of proficiency is less than the threshold in S103 for an occupant who has input a voice “I want to listen to Y” in S101, the controller 21 outputs, as the second voice, not a concise message such as “Understood” but a message including confirmation about an audio device function, “Playing Y”, from a speaker as the output interface 25.

After S105, the flow illustrated in FIG. 4 ends.

As mentioned above, in the present embodiment, the controller 21 controls functions according to voice input from the user 11. The controller 21 identifies the user 11. The controller 21 adjusts the degree of conciseness of the response to voice input according to the identified user 11.

According to the present embodiment, the degree of conciseness of the response as output to voice input can be changed according to the user 11, which improves convenience.

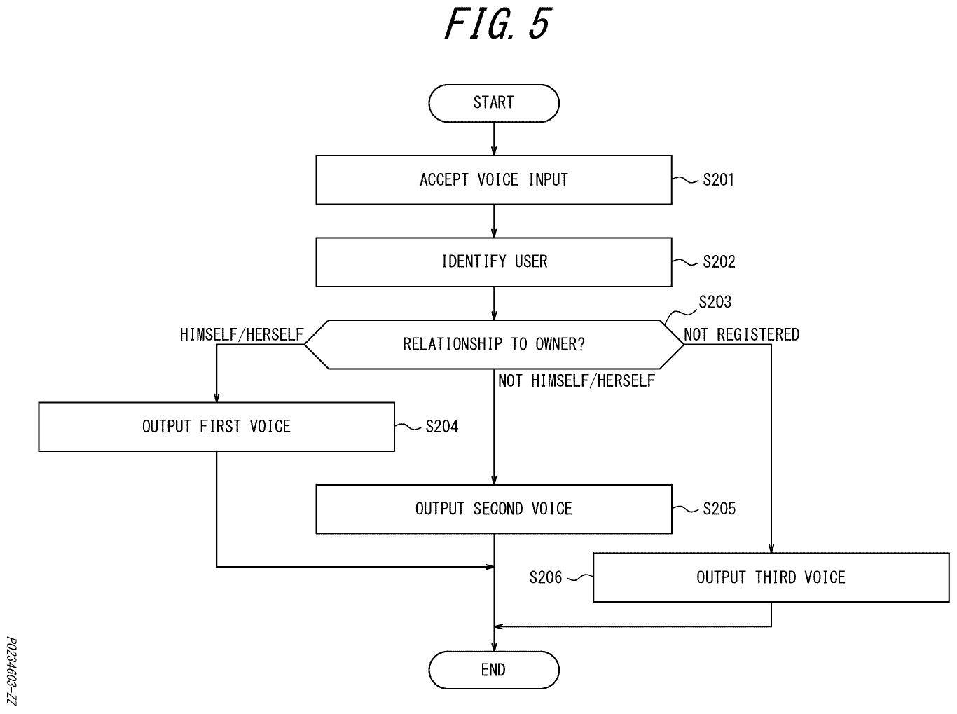

A variation of the operations of the information processing apparatus 20 according to the present embodiment will be described with reference to FIG. 5. However, steps S201, S202, S204, and S205 are the same as steps S101, S102, S104, and S105 illustrated in FIG. 4, respectively, and thus descriptions thereof are omitted.

In S203, the controller 21 determines the user 11's relationship to the owner of the vehicle 12. Specifically, the controller 21 determines the user 11's relationship to the owner of the vehicle 12 with reference to the usage status data 50 as illustrated in FIG. 3. For example, if the user 11 is the owner of the vehicle 12 “himself/herself”, the process proceeds to S204. For example, if the user 11 is a registered user who is not the owner himself/herself, specifically, a user registered as “spouse”, “child”, or “other” in the usage status data 50, the process proceeds to S205. For example, if the user 11 is “not registered”, i.e., not a registered user in the usage status data 50, the process proceeds to S206. As another example, the process may proceed to S205 only if the user 11 is a family member of the owner, specifically, a user registered as a “spouse” or “child” in the usage status data 50. If the user 11 is neither the owner himself/herself nor a family member, i.e., a user registered as “other” in the usage status data 50, or a user with no registration in the usage status data 50, the process may proceed to S206.

In S206, the controller 21 outputs a third voice, different from both the first and second voices, as a response to the voice input received in S101. Specifically, the controller 21 outputs, as the third voice, a voice that includes a confirmation about the function according to the voice input from the user 11 and an additional explanation about the function. For example, if an occupant who has input a voice “I want to listen to Y” in S201 cannot be identified in S202, i.e., the occupant is not registered in the usage status data 50, the controller 21 determines the occupant to be “not registered” in S203. The controller 21 then outputs, as the third voice, not a concise message such as “Understood” but a message including confirmation about an audio device function, “Playing Y”, followed by an additional explanation about the audio device function, “You can request the next song during playback, from a speaker as the output interface 25.

After S206, the flow illustrated in FIG. 5 ends.

In the present embodiment, the controller 21 increases the degree of conciseness of the response to voice input by outputting a voice that omits confirmation about the function according to voice input from the user 11, but the controller 21 may increase the degree of conciseness in other ways. Specifically, the controller 21 may increase the degree of conciseness by reducing one or more terms from the message as a response. For example, in S104 or S204, the controller 21 may output, as a response to the voice input “I want to go to X”, not a message, “X has been set as the destination”, but a message, “X is set”, with the term “as the destination” reduced. Alternatively, the controller 21 may increase the degree of conciseness by outputting the message as a response in broken rather than polite language. In addition, the controller 21 may increase the degree of conciseness by rephrasing the expression in the message as a response to another, shorter expression.

As another variation of the present embodiment, the controller 21 may increase the degree of conciseness to voice input as the level of proficiency increases. For example, the “number of uses” in the usage status data 50 is defined as the level of proficiency, the first threshold is 50, and the second threshold is 10. The controller 21 outputs the first voice if the number of uses by the user 11 is equal to or greater than 50, the second voice if the number of uses by the user 11 is 10 to 49, and the third voice if the number of uses by the user 11 is equal to or less than 9. For the process of outputting the first through third voices, the same process as steps S204 through S206 illustrated in FIG. 5 can be applied, respectively.

The present disclosure is not limited to the embodiment described above. For example, two or more blocks described in the block diagrams may be integrated, or a block may be divided. Instead of executing two or more steps described in the flowcharts in chronological order in accordance with the description, the steps may be executed in parallel or in a different order according to the processing capability of the apparatus that executes each step, or as required. Other modifications can be made without departing from the spirit of the present disclosure.

1. An information processing apparatus comprising a controller configured to:
control a function according to voice input from an occupant of a vehicle;
identify the occupant; and
adjust degree of conciseness of a response to the voice input depending on the identified occupant.

2. The information processing apparatus according to claim 1, wherein the controller is configured to increase the degree of conciseness by outputting, as the response, a voice that omits confirmation about the function.

3. The information processing apparatus according to claim 1, wherein the controller is configured to:
determine, upon identifying the occupant, the occupant's level of proficiency in using the information processing apparatus with reference to usage status data indicating the occupant's usage status of the information processing apparatus; and
increase the degree of conciseness as the determined level of proficiency increases.

4. The information processing apparatus according to claim 1, wherein the controller is configured to adjust the degree of conciseness depending also on the occupant's relationship to an owner of the vehicle.

5. A control method comprising:
controlling, by a computer, a function according to voice input from an occupant of a vehicle;
identifying, by the computer, the occupant; and
adjusting, by the computer, degree of conciseness of a response to the voice input depending on the identified occupant.
